(19) United States
(12) Patent Application Publication
(10) Pub. No.: US 2018/0209123 A1
(43) Pub. Date: Jul. 26, 2018

(54) HYBRID ATMOSPHERIC WATER GENERATOR

(71) Applicant: Simon Fraser University, Burnaby (CA)

(72) Inventors: Majid Bahrami, North Vancouver (CA); Farshid Bagheri, Burnaby (CA)

(73) Assignee: Simon Fraser University, Burnaby (CA)

(21) Appl. No.: 15/576,600

(22) PCT Filed: May 24, 2016
(86) PCT No.: PCT/CA2016/050584

§ 371 Date: Nov. 22, 2017

Related U.S. Application Data
(60) Provisional application No. 62/165,728, filed on May 22, 2015.
(60) Provisional application No. 62/265,880, filed on Dec. 10, 2015.

(51) Int. Cl. E03B 3/28; F24F 3/14; B01D 5/00; B01D 53/26; B01D 53/06; B01D 53/04

(52) U.S. Cl. CPC E03B 3/28; F24F 3/1405; B01D 5/0075; B01D 53/265; B01D 2257/80; B01D 53/06; B01D 53/0407; F24F 2003/1446; B01D 53/261

(57) ABSTRACT

A hybrid atmospheric water generator (HAWG) utilizing, in certain embodiments, a core atmospheric water generator (105) and a preconditioning unit (110) to increase humidity of air prior to water condensation. The core atmospheric unit comprises a condensing unit (106) having a water condensing heat exchanger (107) coupled to source of cooling (109). The preconditioning unit (110) includes a heat exchanger (112) and a sorption unit (114) configured to store moisture for release when air is passed through or near the sorption unit (114). The heat exchanger (112) is used to increase the temperature of air moving into or through the preconditioning unit (110) in order to increase the amount of moisture the air is able to store. The preconditioning unit enables the generation of more water per energy unit expended and/or generating water from ambient air under conditions in which traditional atmospheric water generators cannot function.

### CROSS-REFERENCES TO RELATED APPLICATIONS

This application claims the benefit of U.S. Patent Application Nos. 62/165,728, filed May 22, 2015, and 62/265,880, filed Dec. 10, 2015, the disclosures of which are hereby incorporated by reference in their entirety.

### BACKGROUND

As a result of population increase, urbanization, and industrialization, the global water consumption by humans is highly increasing each year.

Freshwater is utilized for agriculture, energy production, industrial fabrication as well as human and ecosystem needs. Between various water consuming sectors, the domestic sector is more sensitive to the quality and accessibility of clean water. The variations of global water withdrawal of the domestic sector between 1950 and 2010 indicates that global domestic water usage has risen by a factor of 3.7, which equals to an average annual growth rate of 2.2% over the last 60 years.

The distribution of freshwater around the globe is highly uneven, leading to regional shortages or excesses of water resources. The most commonly used index to determine magnitude of regional water resources is the Falkenmark Stress Indicator (FSI), which classifies a country in different categories of water shortage based on per capita liquid water resource availability (PWR). Based on this index, Table 1 represents the countries that are predicted to experience water stress or scarcity by 2025.

TABLE 1
Countries predicted to experience water stress or
scarcity by 2025 (Source: W. A. Jury, H. J. Vaux, The emerging global
water crisis: managing scarcity and conflict, 95 (2007))

| | Water stressed | |
|---|---|---|
| Below water barrier | PWR - 500 | Water scarce |
| PWR <500 m³ year¹ | 1000 m³ year¹ | PWR - 1000 1700 m³ year¹ |
| Algeria | Comoros | Belgium |
| Babrain | Cyprus | Burkina Faso |
| Barbados | Egypt | Eritrea |
| Burundi | Ethiopia | Gbana |
| Cape Verde | Haiti | India |
| Israel | Iran | Lebanon |
| Jordan | Kenya | Lesotho |
| Kuwait | Malawi | Mauritius |
| Libya | Morocco | Niger |
| Malta | Somalia | Nigeria |
| Oman | South Africa | Peru |
| Qatar | UAE | Poland |
| Rwanda | | South Korea |
| Sandi Arabia | | Syria |
| Singapore | | Tanzania |
| Tunisia | | Togo |
| Yemen | | Uganda |
| | | United Kingdom |
| | | Zimbabwe |

Due to existence of hardly removable toxic compounds released from industrial effluents and agricultural pesticide run-offs to the surface or underground water resources, the conventional drinking water treatment methods based on coagulation-flocculation, sedimentation, sand filtration, disinfection, ozonation, and desalination have been proven not completely effective nowadays. Furthermore, as a result of utilization of different chemicals in these treatment procedures for removing suspended materials and for disinfection, several carcinogenic and mutagenic by-products emerge that are hazardous for human health. In addition to water treatment stage, not only the costs of construction and maintenance of water delivery networks are relatively high, but also any collapses of this network can remarkably affect human health and security.

As a result of global drought propagation as well as the abovementioned challenges/shortcomings of so-called centralized water provision and delivery systems, an idea of decentralized atmospheric water generation systems was emerged and followed by researchers and manufacturers during the last two decades. An atmospheric water generator (AWG) operates based on vapor compression refrigeration (VCR) process to extract water from air by cooling and dehumidification. The atmosphere surrounding the earth is estimated to contain a total of over 12.9E12 cubic meter of renewable water. This amount is even greater than the total available freshwater in marshes, wetlands and rivers around the world. Based on the provided information from manufacturers of AWGs, the cost of harvesting 1 liter of water using their products is 0.01-0.02 $/liter, which is more than 30 times that of common desalination systems (0.45-0.52 $/cubic meter). Furthermore, a serious problem of the current AWGs is high capacity drop in dry regions due to low performance of vapor compression refrigeration (VCR) units, which is at the core of any AWG.

Despite that the main market of the AWG units should be in dry areas with shortage of water supply, the existing units have shown the poorest performance and lowest capacity in those areas. Accordingly, the available units are incapable of generating adequate water that makes them practically useless through their main market. Therefore, it would be highly desirable to develop an improved AWG that ensures a high rate of water generation even in dry zones with high efficiency and low costs.

Atmospheric Water Generators (AWGs) Development

In 1900, an apparatus was patented by E. S. Belden that could extract water from air using a cooling process (U.S. Pat. No. 661,944). Basically, an AWG unit is a typical vapor compression refrigeration (VCR), i.e., an air conditioning system that condensates water from air by cooling it below the dew point temperature. It does not comprise any additional component than ordinary refrigeration units, as illustrated in FIG. 1, which is a schematic of a typical AWG based on vapor compression refrigeration cycle. In these units, the compressor sucks the refrigerant gas from the evaporator and after compression, discharges the high pressure and temperature gas toward the condenser. Through the condenser, the gas is condensed as a result of heat rejection to a secondary flow (usually air or water) and a saturated or sub-cooled liquid goes to the expansion valve. As a result of throttling through the expansion valve, the pressure and temperature of the refrigerant drops drastically and a low pressure and temperature two-phase refrigerant flows into the evaporator. The cooling effect of a VCR cycle appears in the evaporator through which the refrigerant evaporates. This evaporation results in heat absorption from air stream flowing around the evaporator coil that cools it down below the dew point temperature and leads to the water generation phenomenon.

Although the first AWG was built in early 20^{th} century, the first mass production of the AWG units was initiated in the beginning of 21^{st} century. Currently, several companies are mass producing the AWG units in residential and commercial sizes. These units are capable of water generation capacity in a range of several to 1,000 liters per day depending upon the system size and atmospheric condition. The main challenge of existing AWG units is that their water generation capacity and performance drops drastically in dry regions due to significantly lower dew point temperature and water content in the ambient air. However, a major demand for these units exists in the dry regions due to water resources scarcity. Further development of AWG technology is required in order to meet future global water needs.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a hybrid atmospheric water generator (HAWG) is provided. In one embodiment, the HAWG includes:

(a) a core atmospheric water generator having an inlet for receiving moisture-containing air and a condensing unit configured to produce condensed liquid water; and

(b) a preconditioning unit configured to increase the humidity of the moisture-containing air prior to introducing the moisture-containing air into the inlet of the core atmospheric water generator.

In another aspect, a method of generating liquid water using a HAWG disclosed herein is provided. In one embodiment, the method includes:

(a) exposing the preconditioning unit to air having a first humidity;

(b) within the preconditioning unit increasing the humidity of the air to provide moist air having a second humidity that is greater than the first humidity;

(c) directing the moist air into the core atmospheric water generator; and

(d) producing liquid water in the core atmospheric water generator.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a schematic of a typical atmospheric water generator (AWG) based on a vapor compression refrigeration cycle;

FIGS. 2A and 2B are schematics of representative hybrid atmospheric water generators (HAWG) in accordance with embodiments disclosed herein;

FIG. 3 is a schematic of a representative core atmospheric water generator, useful in a HAWG, in accordance with embodiments disclosed herein;

FIG. 4 is a schematic of a representative preconditioning unit, useful in a HAWG, in accordance with embodiments disclosed herein;

FIGS. 5A and 5B are schematics of representative preconditioning unit configurations, useful in a HAWG, in accordance with embodiments disclosed herein;

FIGS. 5C and 5D are schematics of representative packed-bed preconditioning unit configurations, useful in a HAWG, in accordance with embodiments disclosed herein;

FIG. 5E is a schematic of a representative desiccant wheel preconditioning unit, useful in a HAWG, in accordance with embodiments disclosed herein;

FIG. 6A is a schematic of a representative HAWG, including a desiccant wheel in accordance with embodiments disclosed herein;

FIG. 6B is a schematic of a control unit for controlling a HAWG, such as that of FIG. 6A, in accordance with embodiments disclosed herein;

FIG. 7A is a schematic of a representative HAWG, including a desiccant wheel and a heat source in thermal communication with a heat driver chiller and a heat exchanger, in accordance with embodiments disclosed herein;

FIG. 7B is a schematic of a control unit for controlling a HAWG, such as that of FIG. 7A, in accordance with embodiments disclosed herein;

FIG. 8 is a 3D rendering of a representative HAWG, in accordance with embodiments disclosed herein;

FIG. 9 is a photograph of an exemplary working packed-bed HAWG, in accordance with embodiments disclosed herein;

FIG. 10 is a photograph of an exemplary working desiccant wheel HAWG, in accordance with embodiments disclosed herein; and

FIG. 11 is a graph comparing coefficient-of-performance for an exemplary HAWG based on varying condenser fan rate and evaporator fan rate.

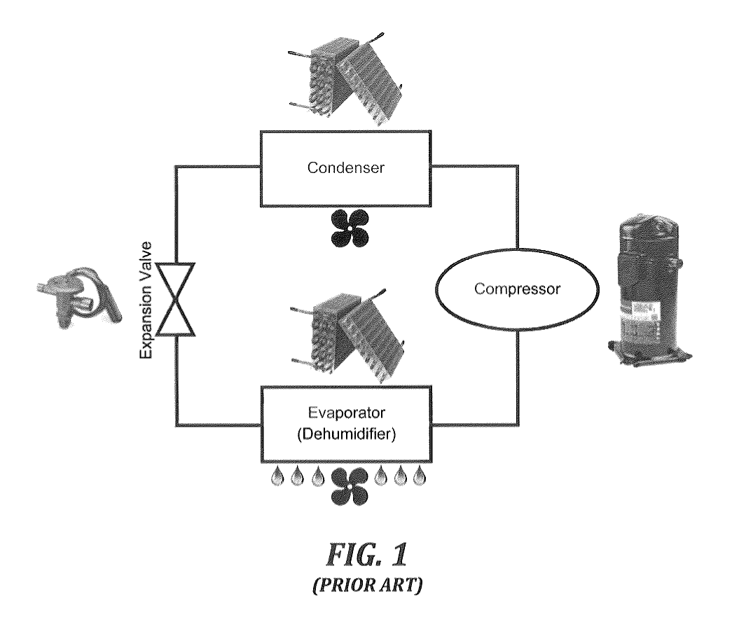

### DETAILED DESCRIPTION

The inventors' studies indicate that the existing AWG units show their best performance in the warm and humid climatic condition. However, the water generation capacity of the current units drops dramatically in the dry regions or cold climatic conditions. Because most of the regions with shortage of water resources are located in the dry climates, the existing AWG units perform unsatisfactorily over those areas; thus, a new solution is required. The reason of this poor efficiency is the relatively low water content and dew point temperature of the atmosphere in such areas. The VCR unit of an AWG machine should spend most of its power in those areas to reduce the air temperature to a significantly low dew point temperature to start water extraction. Accordingly, most of the power consumption by the unit is wasted only for achieving the low dew point temperature. However, in warm and humid areas due to high dew point temperature, a smaller portion of the VCR unit's power is used for temperature reduction (sensible energy) and most of the power is spent for water condensation (latent energy), which is the desired process. Based on the inventors' studies of existing AWG units, the units perform much more efficiently if they operate under a hot and humid inlet air.

In view of this potential improvement, the disclosed embodiments are termed “hybrid” atmospheric water generators (HAWG), which utilize a preconditioning unit in order to increase humidity of air prior to water condensation (e.g., using a VCR unit). The preconditioning unit provides dramatically improved water generation efficiency compared to traditional atmospheric water generators (AWG), thereby enabling the generation of more water per energy unit expended (i.e., lower cost per liter generated) and/or generating water from ambient air under conditions in which traditional AWGs cannot function.

In one aspect, a hybrid atmospheric water generator (HAWG) is provided. In one embodiment, the HAWG includes:

(a) a core atmospheric water generator having an inlet for receiving moisture-containing air and a condensing unit configured to produce condensed liquid water; and

(b) a preconditioning unit configured to increase the humidity of the moisture-containing air prior to introducing the moisture-containing air into the inlet of the core atmospheric water generator.

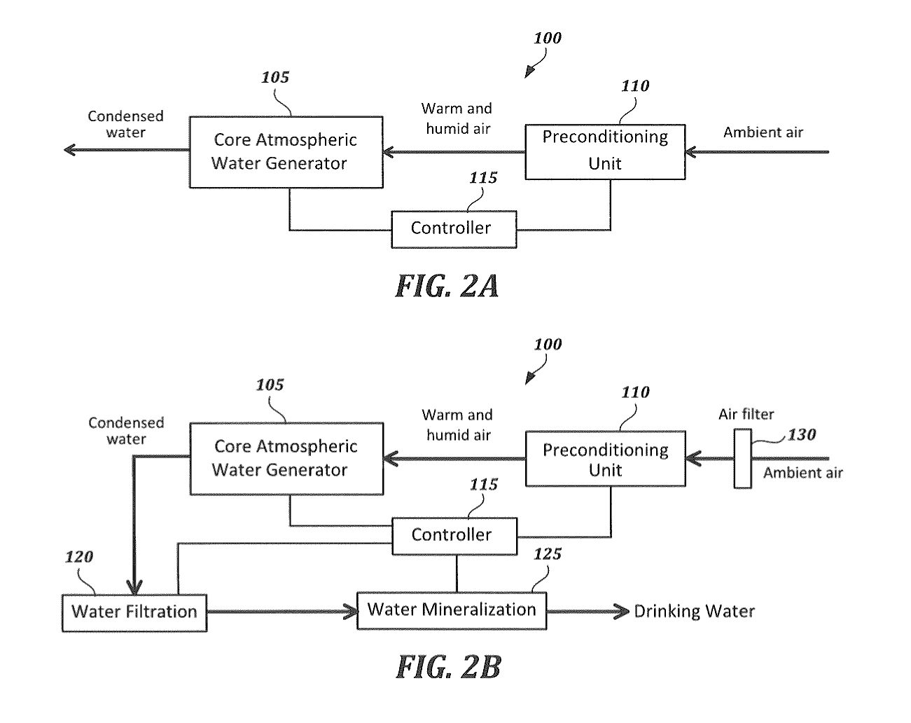

A schematic representation of a HAWG according to the disclosed embodiments is provided in FIG. 2A. The HAWG 100 includes a core AWG 105, a preconditioning unit 110 configured to provide moisture-containing air of a higher humidity than the ambient air to the core AWG 105. The core AWG 105 condenses and captures liquid water from the moisture-containing air, thereby providing condensed water. In the embodiment illustrated in FIG. 2A, a controller 115 is included that is communicatively linked to the core AWG 105 and the preconditioning unit 110 in order to control their operation for desired and/or optimal performance.

Preconditioning Unit

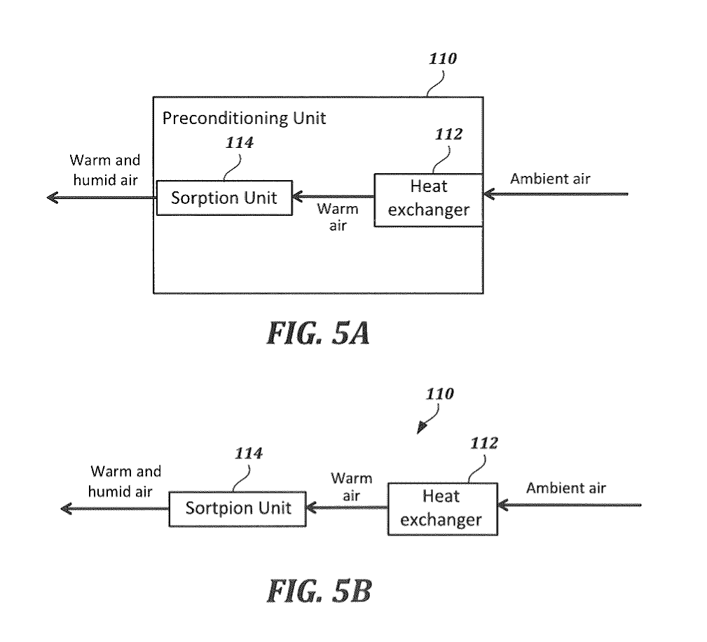

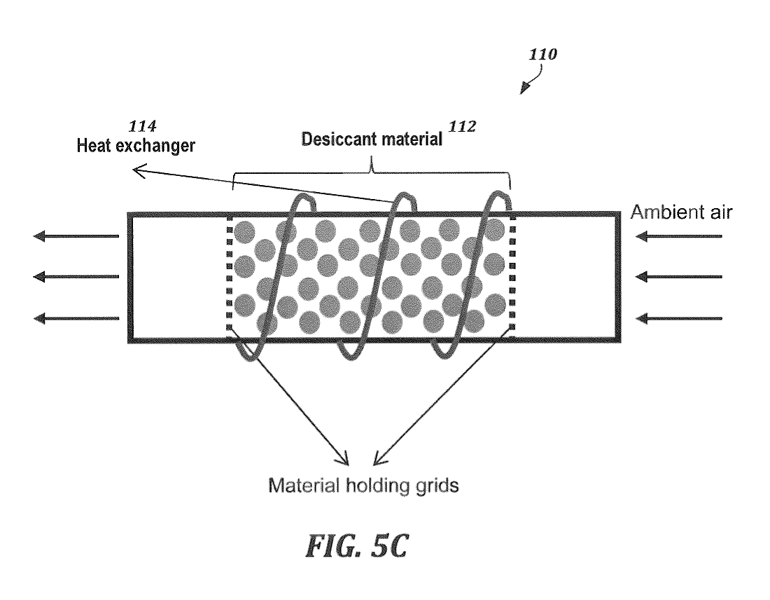

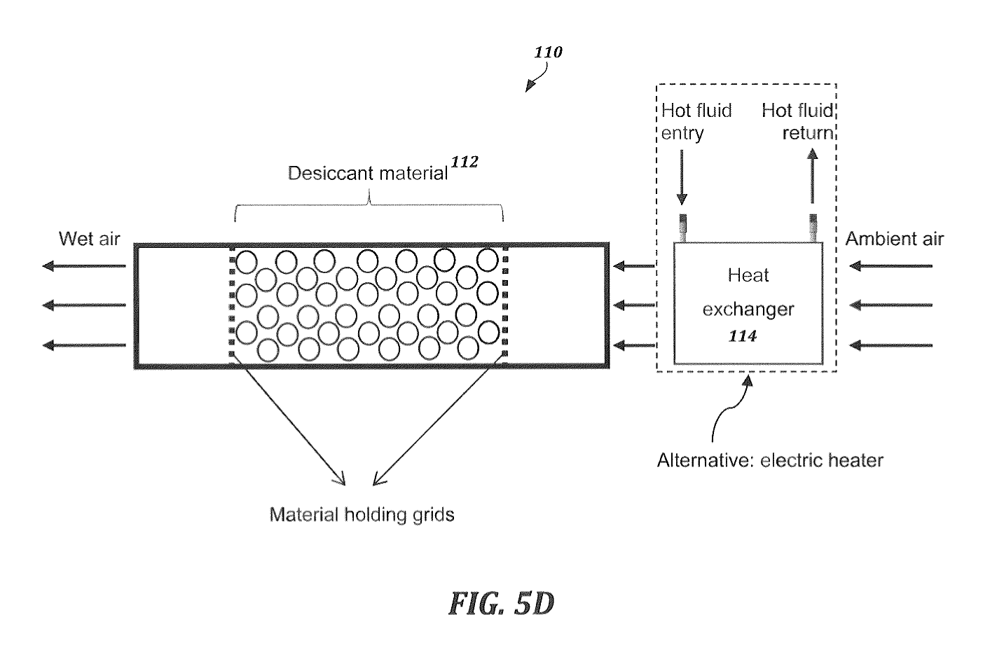

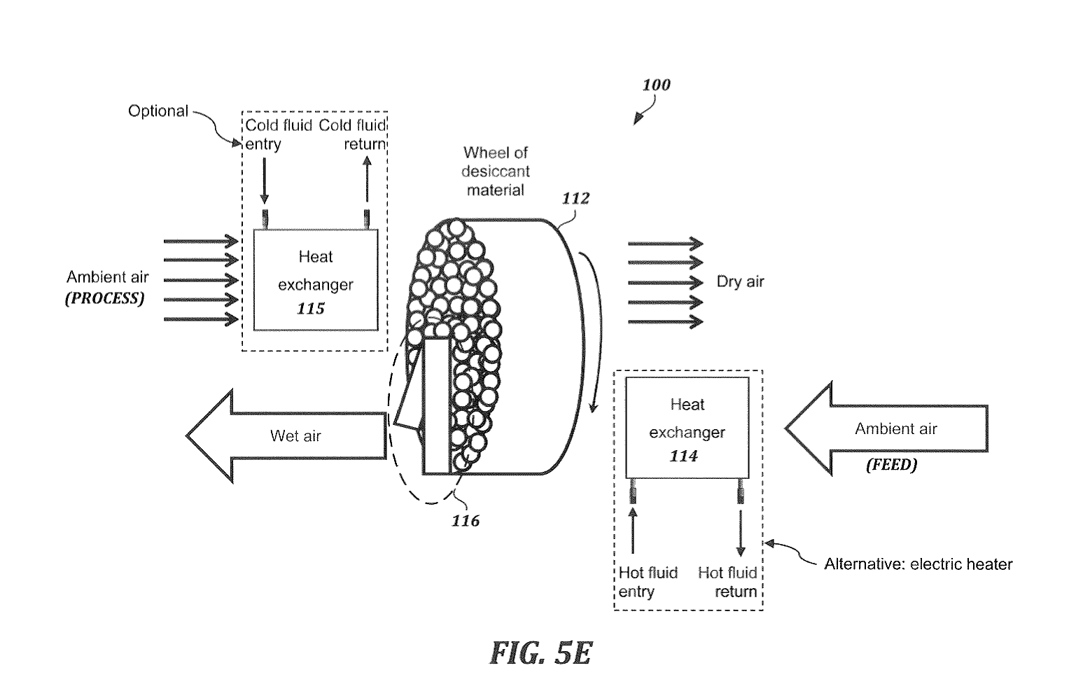

The preconditioning unit 110 functions to increase the amount of moisture (water) contained in air that is passed through the unit 110. In order to accomplish this, the unit 110 includes at least one component configured to store moisture that can then be released into air passing through the unit 110. A representative representation of a preconditioning unit 110 is illustrated in FIG. 4 and includes at least one heat exchanger 112 and at least one sorption unit 114. The sorption unit 114 (or units) is configured to store moisture for release when air is passed through or near them. A heat exchanger 112 is used to increase the temperature of air moving into or through the preconditioning unit 110 in order to increase the amount of moisture the air is able to store, due to the fact that warmer air holds more moisture. While FIG. 4 illustrates the preconditioning unit 110 as a single component, it will be appreciated that the subcomponents of the unit 110, namely the sorption unit 114 and heat exchanger 112 are disposed in the same enclosure in one embodiment (FIG. 5A) but in other embodiments the two components, the heat exchanger 112 and sorption unit 114, are separate components that are disposed adjacent to one another so as to maintain proximity sufficient to provide the needed heating of ambient air and transfer of warm air from the heat exchanger 112 to the sorption unit 114.

In one embodiment, the preconditioning unit comprises:

an inlet configured to intake air of a first humidity; and

an outlet in communication with the core atmospheric water generator configured to output air of a second humidity that is greater than the first humidity.

By taking in air of the first humidity and outputting air of a second humidity that is greater than the first humidity, the preconditioning unit 110 performs its function of increasing the moisture content of the ambient air so as to allow the core AWG 105 to extract more condensed water than if the preconditioning unit 110 were not employed. This improvement provides up to and beyond 100% efficiency improvement compared to traditional AWG technologies.

In one embodiment, the HAWG further includes a heat exchanger configured to heat the sorption unit. The heat exchanger 112 can be any heat exchanger configured to transfer heat to air passed in its proximity. Both fluid-filled coils and resistive electric heaters are exemplary heat exchangers 112. In one embodiment, the preconditioning unit is further configured to increase the temperature and humidity of the moisture-containing air prior to introducing the moisture-containing air into the inlet of the core atmospheric water generator.

Sorption Bed. The sorption unit 114 is configured to store moisture and in one embodiment, the preconditioning unit 114 comprises at least one sorption bed. As used herein, a sorption bed is a material disposed so as to allow air to pass through and either collect or release moisture (e.g., via absorption/desorption or adsorption/desorption). In certain embodiments the sorption bed is a container filled with granules or a porous solid configured to collect and release moisture.

In one embodiment, the sorption bed is configured to adsorb and desorb water.

In one embodiment, the sorption bed comprises a desiccant material. In one embodiment, the desiccant material is selected from the group consisting of gas, liquid, or solid phases of silica gel, molecular sieves, zeolites, activated charcoal, activated alumina, calcium sulfate, calcium chloride, calcium oxide, montmorillonite clay, and combinations thereof.

In one embodiment, the desiccant material is configured to adsorb water from the air in an exothermic process and desorb water into the air in an endothermic process. Accordingly, in certain embodiments a heat exchanger is used to cool the desiccant material when adsorbing water so as to enhance capture of water and store more water for subsequent release during desorption.

In one embodiment, the HAWG further includes a fan configured to direct air into the preconditioning unit.

Turning now to FIG. 5C, an example of a sorption bed is illustrated in the context of a precondition unit 110 that includes a heat exchanger 114, illustrated as a coil that could be resistive or fluid-containing, and a sorption bed 112 of desiccant material. FIG. 5D is a variation on the preconditioning unit 110 that includes a sorption bed 112 of desiccant material but instead of a wrapped heat exchanger there is instead a heat exchanger 114 configured to heat the ambient air prior to entering the sorption bed.

In operation, the sorption bed can be charged by adsorbing moisture from air and then discharged by flowing warm air over the charged bed. This results in a charge/discharge cycle. Several sorption beds can be used in parallel such that there are always beds charging and discharging at any time, so as to provide continuous flow.

Desiccant Wheel. In one embodiment, the preconditioning unit comprises a desiccant wheel. A desiccant wheel provides a preconditioning unit 110 whereby continuous charge/discharge is provided by a rotating wheel, as illustrated in FIG. 5E. In this configuration, the preconditioning unit 110 includes a rotating wheel 112 filled or coated with desiccant material, either a continuous expanse or in the form of a plurality of packed beds (as discussed above). A heat exchanger 114 provides heating to ambient air (“Feed”) that then flows through a portion 116 of the wheel 112 that is moisture-containing. The “wet air” is then moved to the core AWG 105. The portion 116 is illustrated here as a wedge of the wheel 112 but it will be appreciated that any size or shape portion 116 can be used. The wheel 112 rotates, either continuously or incrementally so as to move the desiccant material from a discharge position to a charging position. In the charging position, “process” air that is moisture containing is moved through an optional heat exchanger 115 to cool the air before it impinges on the wheel 112 so as to charge it and adsorb moisture. As the wheel 112 rotates it is charged (at the top of the image) and discharged at the bottom within the portion 116. By this operation the wheel sorption unit 112 is continuously charging and discharging for continuous water generation.

Accordingly, in one embodiment, the desiccant wheel is configured to rotate in order to expose a dry portion of the desiccant wheel to a charging air stream, providing ambient air, and a moist portion of the desiccant wheel to a drying air stream directed into the core atmospheric water generator. In one embodiment the wheel rotates at a rate of 0.5 to 60 revolutions per hour. In another embodiment the wheel rotates at a rate of 6 to 16 revolutions per hour.

Core AWG

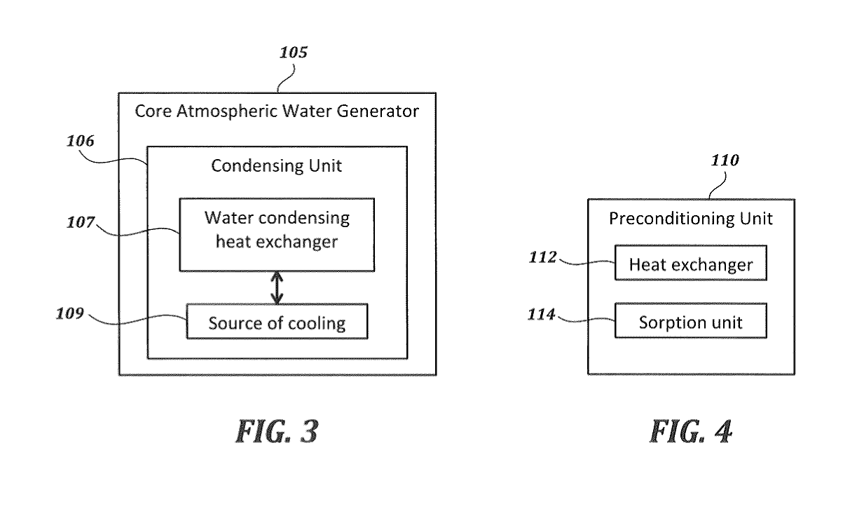

The core AWG 105 can be any AWG configured to provide condensed liquid water from moisture-containing air. Referring to FIG. 3, the core AWG 105 includes a condensing unit 106 that produces condensed liquid water by cooling “wet” air from the preconditioning unit 110. In one embodiment, the condensing unit 106 is configured to use chilled fluid or evaporating refrigerant to provide a cooling source sufficient to condense liquid water from the moisture-containing air.

The condensing unit 106 further includes a water condensing heat exchanger 107 and a source of cooling for the heat exchanger 107. Any known heat exchangers and sources of cooling are compatible with the disclosed embodiments.

AWG technology is generally known, with VCR technology typically used in known AWG systems. VCR technology is compatible with the disclosed HAWG embodiments. In one embodiment, the core atmospheric water generator comprises a vapor compression refrigeration system (VCR) configured to condense water from the moisture-containing air by cooling it below its dew point.

In one embodiment, the condensing unit comprises a water condensing heat exchanger coupled to a source of cooling. In one embodiment, the source of cooling operates based on a systems selected from the group consisting of: i) vapor compression refrigeration (VCR), ii) adsorption cooling; iii) absorption cooling, iv) thermoelectric cooling, vi) gas cycle cooling, vii) air cycle cooling, viii) magnetic refrigeration ix) thermoacoustic refrigeration, x) reverse Stirling cooling, xi) evaporative cooling, xii) steam jet cooling, xiii) pulse-tube refrigeration, xiv) dilution refrigeration configured to condense water from the moisture-containing air by cooling it below its dew point, and combinations thereof.

Controller

Referring to FIG. 2A, the controller 115 controls operation of the HAWG by monitoring operating parameters using sensors and controlling heating, cooling, flow rates, rotating speeds and other parameters in order to provide the desired operating characteristics, such as optimal efficiency water generation. The controller 115 is any circuit-based logic device capable of receiving sensor inputs, processing the inputs based on a thermo-economic model predictions to provide a state of operations, receiving instructions based on the inputs, and controlling components of the HAWG 100 to produce the desired results based on the input instructions. Exemplary controllers 115 include integrated circuits, sensors, actuators, data acquisitions and storage, wireless and Bluetooth connections, internet connectivity, and apps for remote control and monitoring of the HAWG, computers of all types, FPGAs, and ASICs.

In one embodiment, the HAWG further includes an optimization-based operation controller configured to efficiently control the functionality of the HAWG to achieve a high rate of water generation with the lowest energy consumption intensity.

In one embodiment, the controller is configured to monitor operating parameters via one or more sensors related to operation of the HAWG.

In one embodiment, the controller controls operating parameters selected from the group consisting of speed of fans, heat exchanger cooling and heating capacity, a speed of a wheel desiccator, a capacity of the core atmospheric water generator, and combinations thereof.

In one embodiment, the HAWG further includes one or more sensors configured to monitor air temperature, humidity, or a combination thereof as related to the HAWG operation.

Additional Components

In another embodiment of a HAWG, illustrated in FIG. 2B, a system similar to FIG. 2A is illustrated but with additional components. Particularly, the HAWG 100 additionally includes a water filtration component 120 in order to purify and filter the condensed water. In one embodiment, the HAWG further includes a water filtration system configured to eliminate impurities and organics from the condensed liquid water. In one embodiment, the filtration is sufficient to provide drinking water from the condensed liquid water. Filter technologies are well known and will not be discussed in great detail. The filter can be monitored and controlled by the controller 115.

Still referring to FIG. 2B, also included is a water mineralization component 125 configured to add minerals to the condensed water in order to provide water having mineral character similar to traditional western drinking water. In one embodiment, the HAWG further includes a water mineralization system configured to add minerals to the condensed water. HAWG-produced water is characteristically low in mineral contents, hardness, alkalinity, and pH. Therefore, in one embodiment the HAWG water is conditioned/mineralized prior to final distribution and use. Mineralization aims to: i) provide protection of the water distribution against corrosion; and 2) add essential minerals needed to meet human dietary needs and facilitate other potential uses of the HAWG water such as irrigation or agriculture. For instance, chemicals containing calcium (i.e., lime, calcite, calcium hypochlorite) or calcium and magnesium (i.e., dolomite) are typically added in dosage of 60 to 120 mg/L (as CaCO₃). Such mineralization technologies are known and include tablets or solutions provided in a defined volume of water so as to provide the desired concentrations of minerals. This process can be automated by the controller 115.

In one embodiment, the mineralization is sufficient to provide drinking water from the condensed liquid water. In a further embodiment, both filtration and mineralization are used to provide drinking water.

As used herein, “drinking water” is defined as water that meets the characteristics set forth in the publicly available October 2014 Guidelines for Canadian Drinking Water Quality.

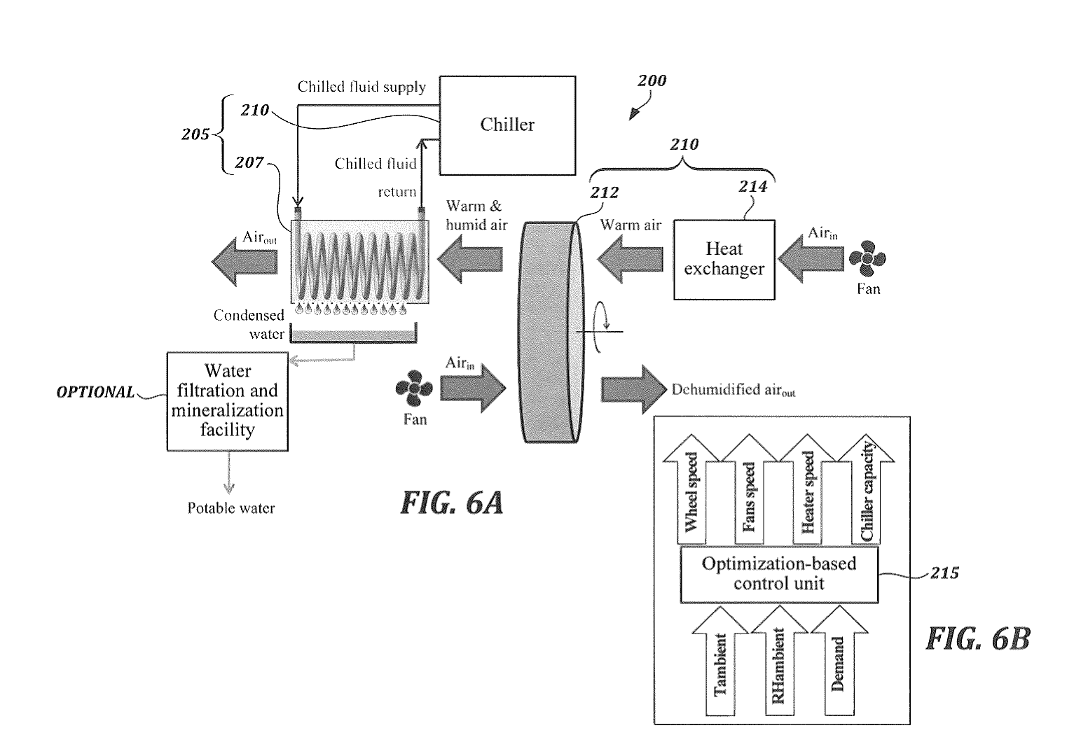

In one embodiment, the HAWG further includes one or more fans, each configured to move air to, away from, or between the components of the HAWG. As illustrated in several FIGURES, including, for example, FIG. 6A, several fans can be used to drive air through the HAWG 200, including a fan to supply process air to “charge” the sorption unit 212 and a second fan to move ambient feed air through the preconditioning unit 210 and into the core AWG 205.

In one embodiment, the HAWG further includes at least one air filter configured to remove dust and impurities from the moisture-containing air before entering the condensing unit or the sorption unit or both. Air filter technology is well known and any filter type can be applied to the HAWG 100.

Electricity-Driven HAWG (“EHAWG”)

Referring to FIGS. 2A and 3, in certain embodiments, electricity is used to drive the core AWG 105, and particularly to provide the source of cooling 109. Such an embodiment is referred to herein as an EHAWG, due to the reliance on electricity for cooling. In one embodiment, chilled fluid is provided by an electricity-driven chiller. In one embodiment, chilled fluid is provided by evaporating refrigerant that is provided by an electricity-driven VCR system.

In one embodiment, the electricity-driven chiller is of a type selected from the group consisting of a vapor compression refrigeration chiller, direct expansion vapor compression refrigeration system, a thermoelectric cooling system, a gas cycle cooling system, an air cycle cooling system, a magnetic refrigeration system, a thermoacoustic refrigeration system, a reverse Stirling cooling system, a evaporative cooling system, a steam jet cooling system, a pulse-tube refrigeration system, a dilution refrigeration system, and combinations thereof.

In one embodiment, the electricity-driven chiller is also configured to receive fluid returned from the condensing unit that is of a temperature greater than the chilled fluid.

A representative HAWG 200 system is illustrated in FIG. 6A that includes a core AWG 205 that includes a water condensing heat exchanger 207 and a chiller 210. In certain embodiments the chiller 210 is electrically-driven and such a system is considered an EHAWG. The HAWG 200 further includes a preconditioning unit 210 that includes a sorption unit 212 (in the form of a desiccant wheel as described with regard to FIG. 5E) and a heat exchanger 214. The accompanying fans, water filtering, water mineralization, and controller 215 (FIG. 6B) are also provided. In other embodiments where the chiller 210 is not electric the illustrated HAWG 200 is not an EHAWG.

Referring still to FIGS. 6A and 6B, the HAWG 200 operates by first charging the desiccant wheel 212 with moisture by running ambient air through it. The air is optionally cooled by a heat exchanger (not illustrated). The charged portion of desiccant 112 is then rotated around until it encounters warm air provided by the heat exchanger 214. The warm air passes through the charged desiccant 112 and becomes warm and humid (“wet”). The wet air then passes into the core AWG 205 where it encounters the water condensing heat exchanger 207 (illustrated as a cooling coil). Upon encountering the heat exchanger 207 water condenses and is collected. The water is optionally filtered and mineralized. The heat exchanger 207 is fluidically coupled to the chiller 210, which intakes relatively warm liquid from the exchanger 207 and outputs cooled fluid to the exchanger 207 to maintain a cooled state of the exchanger 207.

All components of the HAWG 200 are controlled by the controller 215, which intakes sensor data and outputs commands for the various components.

Heat-Driven and Sorption-Assisted HAWG (“HSAWG”)

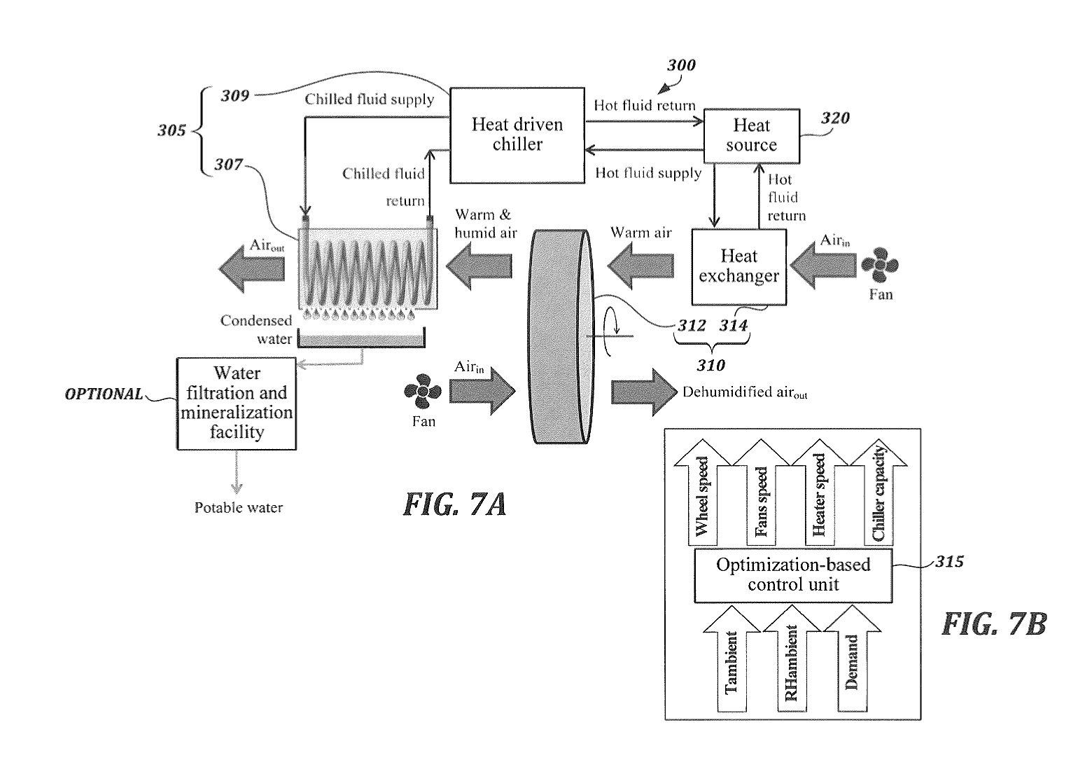

Another representative HAWG 300 system is illustrated in FIG. 7A that includes a core AWG 305 that includes a water condensing heat exchanger 307 and a heat-driven chiller 309. In the illustrated embodiments the chiller 309 is heat-driven and such a system is considered an HSAWG because it is driven by heat instead of electricity. The HAWG 300 further includes a preconditioning unit 310 that includes a sorption unit 312 (in the form of a desiccant wheel as described with regard to FIG. 5E) and a heat exchanger 314. The accompanying fans, water filtering, water mineralization, and controller 315 (FIG. 7B) are also provided.

Distinct from the HAWG 200 of FIG. 6A, the HAWG 300 of FIG. 7A includes a heat source 320 that provides heat to both the heat-driven chiller 309 and the heat exchanger 314. In one embodiment, two separate fluid streams are heated up by the heat source 320 to run the heat-driven chiller 309 and warm up the air stream entering the sorption unit 312. In one embodiment, one fluid stream is heated up by the heat source 320 and first passes through the heat-driven chiller 309 to operate it, then passes through the heat exchanger 314 to warm up the air stream entering the sorption unit 312, and then returns back to the heat source 320.

Operation of the HAWG 300 is similar to that of the HAWG 200, with the exception of the heat source 320 providing heat to the chiller 309 and heat exchanger 314.

All components of the HAWG 300, including the heat source 320, are controlled by the controller 315, which intakes sensor data and outputs commands for the various components.

In one embodiment, chilled fluid is provided by a chiller that is a mechanically-driven chiller, magnetically-driven chiller, thermally-driven chiller, acoustically-driven chiller, or combinations thereof.

In one embodiment, the chiller is also configured to receive fluid returned from the condensing unit that is of a temperature greater than the chilled fluid.

In one embodiment, the chiller operates using a mechanism selected from the group consisting of adsorption, absorption, and a combination thereof.

In one embodiment, the HAWG further includes a thermal energy source configured to provide heated fluid to the chiller and receive cooled fluid from the heat-driven chiller.

In one embodiment, the thermal energy source includes heat from a source selected from the group consisting of electricity, combustion heat, chemical reaction heat, nuclear heat, solar heat, flue gas, exhaust heat, process heat, geothermal heat, waste heat from any application, heat pump, friction heat, compression heat, radiant heat, microwave heat, induction heat, and combinations thereof.

In one embodiment, the HAWG further includes a heat exchanger configured to provide a source of heat to the preconditioning unit in order to increase the temperature of the moisture-containing air, wherein the heat exchanger is in fluid communication with the thermal energy source so as to provide heated fluid to the heat exchanger and receive cooled fluid from the heat exchanger.

In one embodiment, the HAWG further includes one or more heat exchangers configured to provide a source of heat or cold to the preconditioning unit in order to increase or reduce the temperature of the moisture-containing air and process air, wherein the heat exchangers are in fluid communication with the heat source so as to provide heated or cold fluid to the heat exchanger and receive cooled fluid from the heat exchangers, and wherein there is at least one heating heat exchanger and one cooling heat exchanger.

In one embodiment, the HAWG does not include an electricity-driven chiller.

Method of Generating Water Using HAWGs Disclosed Herein

In another aspect, a method of generating liquid water using a HAWG disclosed herein is provided. In one embodiment, the method includes:

(a) exposing the preconditioning unit to air having a first humidity;

(b) within the preconditioning unit increasing the humidity of the air to provide moist air having a second humidity that is greater than the first humidity;

(c) directing the moist air into the core atmospheric water generator; and

(d) producing liquid water in the core atmospheric water generator.

In one embodiment, the air is moved with one or more fans.

In one embodiment, the preconditioning unit comprises at least one sorption bed and a heat exchanger configured to heat the sorption bed, and wherein the method further comprises the steps of:

exothermically adsorbing water in the sorption bed; and subsequently

heating the sorption bed to desorb the water to provide moist air to the core atmospheric water generator.

In one embodiment, the sorption bed is in the form of a linear sorption bed.

In one embodiment, the sorption bed is in the form of multi-layer stackable sorption materials.

In one embodiment, the sorption bed is incorporated into a wheel desiccator.

In one embodiment, the sorption bed allows for continuous water generation.

In one embodiment, liquid water is produced at a higher rate when compared to the core atmospheric water generator without the preconditioning unit.

In one embodiment, liquid water is produced at a rate of 100% or greater when compared to the core atmospheric water generator without the preconditioning unit.

In one embodiment, the operating parameters of the HAWG are optimally controlled based on the ambient temperature and humidity.

In one embodiment, the operating parameters are selected from the group consisting of speed of fans, heat exchanger power, heat exchanger cooling and heat capacity, a speed of wheel desiccator, a capacity of the core atmospheric water generator, and combinations thereof.

The following examples are included for the purpose of illustrating, not limiting, the described embodiments.

### EXAMPLES

### Example 1

### Performance of Commercial AWGs

We tested and simulated the performance of two the high efficiency existing AWG units using different operational conditions. Two typical residential-size and commercial-size AWG units in the market have been studied comprehensively. A variety of measuring equipment including temperature and humidity sensors, digital clamp meter, and anemometer are employed to measure the rate of water generation and power consumption of the units to calculate their performance. The residential unit was connected to an environmental chamber located in the Laboratory for Alternative Energy Conversion (LAEC), Simon Fraser University, BC, Canada, to simulate a variety of realistic operating condition. The environmental chamber could provide a wide range of temperature and humidity at the inlet of residential AWG unit that enabled us to assess the performance of the unit under different operating conditions. The results of our measurements are presented in Table 2. The results indicate that due to the highest rate of water generation and the lowest relevant cost, the unit shows the best performance in Florida summer condition. Also, the results show that the unit can only generate 3.3 liter of water per day in dry regions such as Arizona summer condition with cost of almost 5 times of the cost in Florida summer.

TABLE 2
Performance evaluation of a typical residential AWG
under different ambient condition

| | | | Water | | Energy | Cost* |
|---|---|---|---|---|---|---|
| | Tᵢₙ | RHᵢₙ | generation | Power | (kWh/ | (cents/ |
| Test condition | (° C.) | (%) | (L/day) | (W) | L) | L) |
| Arizona summer | 42 | 14 | 3.3 | 774 | 5.691 | 64.0 |
| Manitoba summer | 29 | 42 | 10.0 | 717 | 1.715 | 19.3 |
| British Columbia | 23 | 58 | 6.9 | 702 | 2.438 | 27.4 |
| summer | | | | | | |
| Florida summer | 33 | 56 | 15.7 | 770 | 1.180 | 13.3 |
| Florida winter | 20 | 77 | 11.4 | 715 | 1.505 | 16.9 |

*Energy costs are calculated based on BC-Hydro Tariff for residential customers: 11.27 (cents/kWh)

A similar performance evaluation was carried out for the commercial unit and the results are presented in Table 3. Similar to the residential unit, the best performance is emerged for Florida summer. The worst condition is related to Manitoba winter that due to low temperature and freezing of the condensed droplets, water extraction by using VCR units is impossible. Also, during the winter season, cost of water generation in most of the considered regions is too high. Thus, based on the performance evaluation of the existing AWG units in the market, the best performance is achievable for warm and humid working conditions. Also, the existing units cannot generate enough water in dry regions or cold climatic conditions.

TABLE 3
Performance evaluation of a typical commercial AWG
under different ambient conditions

| | | | | | Power | Energy |
|---|---|---|---|---|---|---|
| | | | | Required | consump- | cost* |
| | | DBT | RH | air flow | tion | (cents/ |
| City | Season | (F/° C.) | (%) | (ft³/L) | (kWh/L) | L) |
| Arizona | Summer | 108/42 | 14 | 4494 | 2.399 | 40 |
| (Phoenix) | Winter | 52/11 | 43 | 17578 | 9.384 | 158 |
| Florida | Summer | 91/33 | 56 | 2005 | 1.070 | 18 |
| (Miami) | Winter | 68/20 | 77 | 3371 | 1.800 | 30 |
| Manitoba | Summer | 84/29 | 42 | 3170 | 1.692 | 28 |
| (Winnipeg) | Winter | 2/−17 | 83 | Not | Not | Not |
| | | | | working | working | working |
| British | Summer | 74/23 | 58 | 3253 | 1.737 | 29 |
| Columbia | Winter | 38/3 | 82 | 18779 | 10.025 | 169 |
| (Vancouver) | | | | | | |

*Energy costs are calculated based on BC-Hydro Tariff for non-residential customers: 16.86 (cents/kWh)

### Example 2

### Prototype HAWGs in Accordance with Embodiments Disclosed Herein

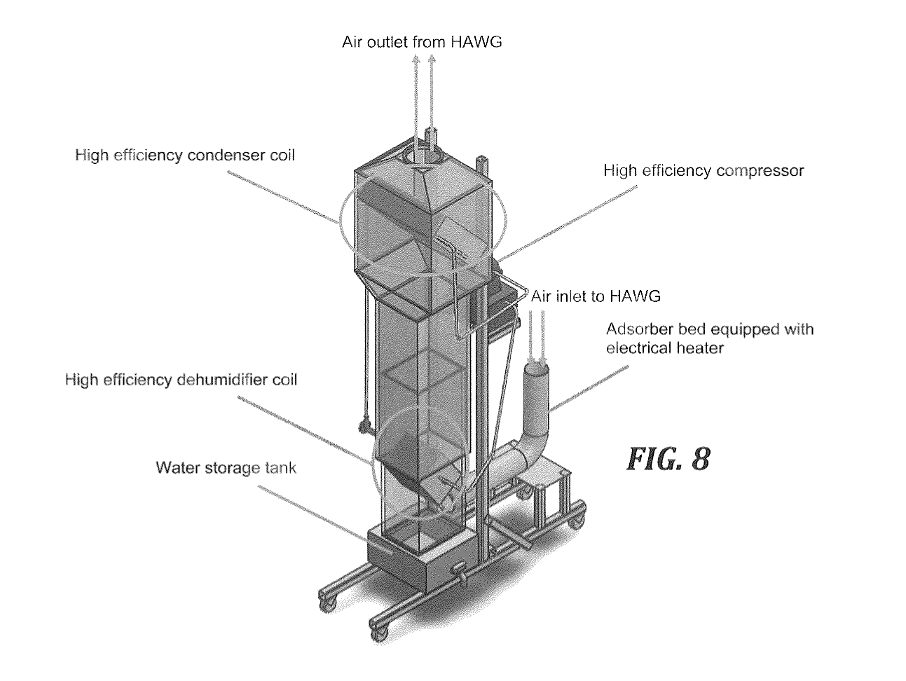

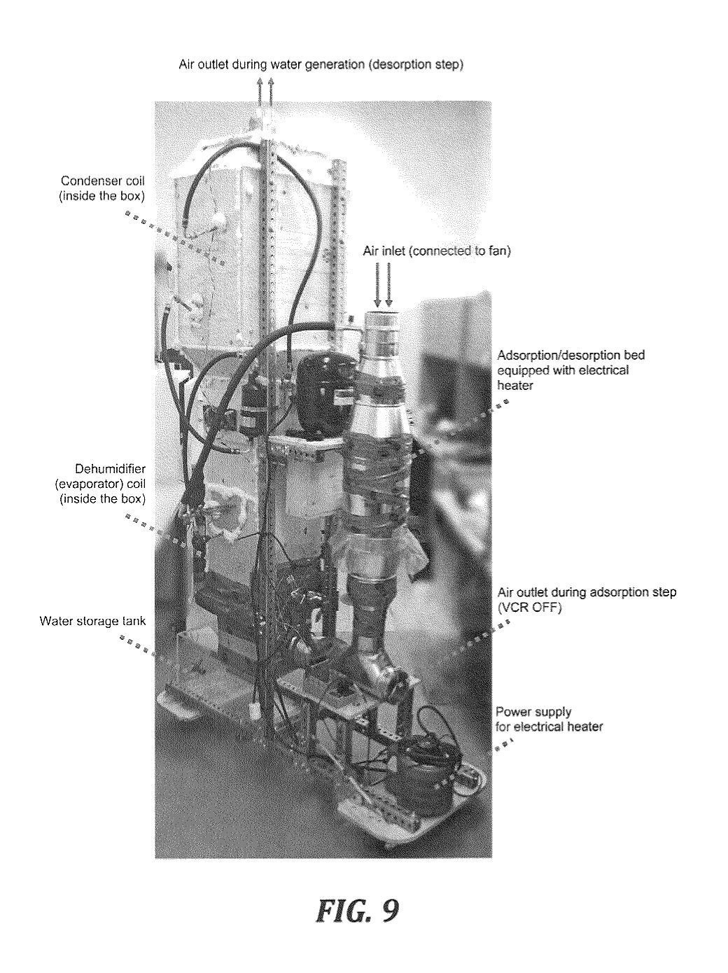

A HAWG was built based on the disclosed parameters. FIG. 8 is a 3D rendering of a design for a representative HAWG and FIG. 9 is a photograph of an exemplary working packed-bed HAWG, according to our design, which is a prototype including an adsorption/desorption packed bed and a VCR unit. Because the VCR uses an electric chiller this prototype would be classified as an EHAWG according to the nomenclature developed herein.

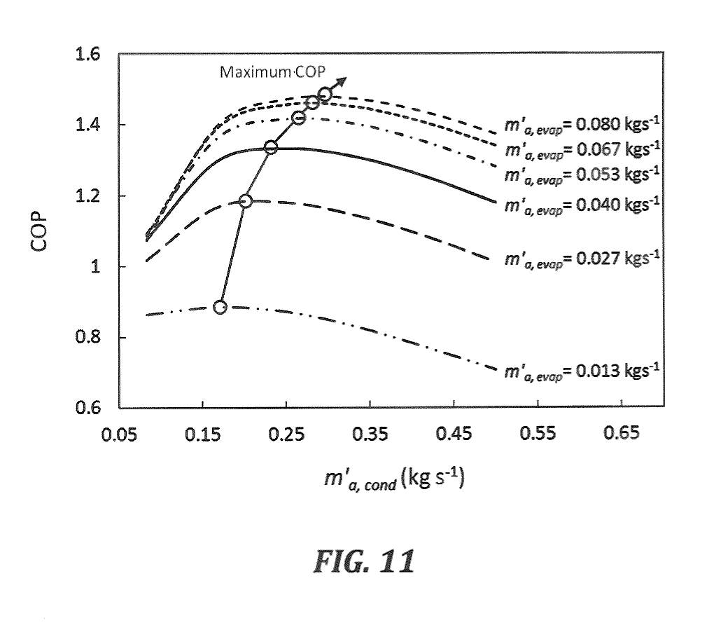

In the exemplary HAWG is also a high efficiency variable speed fan connected to the inlet of adsorption/desorption bed to blow air through the system and a control panel that controls the system. During the adsorption step, the VCR is off while the fan is blowing air through the bed. In this step, the air flow is discharged from the bottom outlet (shown in FIG. 11) and does not pass through the VCR unit. After the bed becomes fully charged, the VCR and electrical heater are switched on and the bottom air outlet is closed. Therefore, ambient air enters the charged bed and gains water and heat from the bed. Accordingly, a warm and humid air leaves the absorber bed and enters the VCR from bottom. After passing through the dehumidifier (evaporator) coil and losing a significant amount of water content, the air stream passes through the condenser coil of VCR unit; cools it down, and finally is discharged to the ambient from top of the HAWG unit. Thus, the VCR unit only operates during the desorption step and receives a warm and humid air stream that makes it working with the highest coefficient of performance. Also, during the adsorption step, the system power consumption is only restricted to a relatively low power consumption by the fan.

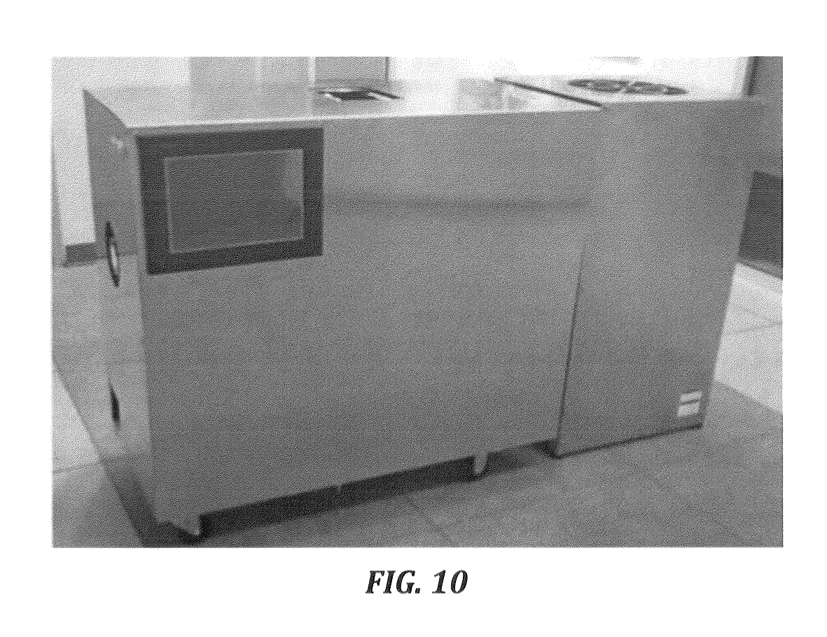

FIG. 10 is a photograph of a prototype EHAWG that utilizes a desiccant wheel instead of a packed bed desiccant. Operating as illustrated in FIG. 6A, this HAWG allows for continuous operation. The pictured prototype EHAWG has a wheel rate of rotation that is typically 6-16 revolutions per hour (RPH), but is capable of 0.5-60 RPH to access a broader range of performance parameters.

Water generated by the EHAWG of FIG. 10 was tested by an independent water testing company, Exova of Surrey, BC, Canada, in order to determine if it was of “drinking water” quality. The test configured that the water sample was “below Maximum Acceptable Concentrations for the chemical and bacteriological health related guidelines specified by the October 2014 Guidelines for Canadian Drinking Water Quality for the parameters tested.” The tested parameters included metals, microbiologicals, physical and aggregate properties, “routine water” properties (e.g., pH, conductivity, hardness, total dissolved solids, etc.). Accordingly, this independent test confirmed that water generated by the EHAWG is suitable as drinking water.

### Example 3

### Performance of Exemplary EHAWG in Accordance with Embodiments Disclosed Herein

We tested the performance of a prototype HAWG unit, as illustrated in FIG. 9, for a variety of ambient conditions (using an environmental chamber) that showed a significantly higher efficiency and rate of water generation compared to the existing AWG units. Table 4 shows a comparison between the performances of HAWG units with a typical high efficiency AWG unit in the market (manufactured by Dew Point, see previous section) under the same ambient condition. An average ambient temperature and humidity, British Columbia summer, is chosen for this comparison. It should be noted that the existing AWG units cannot generate water in dry regions; however, the performance of our HAWG is not a function of ambient condition since the air is always preconditioned before entering the VCR unit. In other words, unlike the existing AWG units that are not working in dry regions, the invented HAWG can generate a desired amount of water independent of the ambient condition. Accordingly, the invented HAWG can work reliably in any ambient condition and generate a desired water quantity with a higher efficiency than any existing AWG unit.

TABLE 4
Performance test results of VCR-based EHAW compared
to conventional AWG

| | | Water Generation | Compressor | Energy* | Cost** |
|---|---|---|---|---|---|
| Test condition | Unit | (liters/day) | Power (W) | (kWh/liter) | (cents/liter) |
| 33° C., 18% Relative | Conventional | 3.3 | 774 | 5.6 | 63 |
| Humidity | AWG | | | | |
| (Arizona Summer) | VCR-based | 13.7 | 1018 | 1.8 | 20 |
| | EHAWG | | | | |
| 32° C., 55% Relative | Conventional | 15.7 | 785 | 1.2 | 13.5 |
| | AWG | | | | |
| Humidity | VCR-based | 27.6 | 1023 | 0.89 | 10 |
| (Florida Summer) | EHAWG | | | | |
| 25° C., 48% Relative | Conventional | 6.9 | 706 | 2.5 | 28 |
| Humidity | AWG | | | | |
| (British Columbia | VCR-based | 23.2 | 985 | 1.0 | 11 |
| Summer) | EHAWG | | | | |
| 6° C., 80% Relative | Conventional | Did not work under these | | | |
| Humidity | AWG | conditions | | | |
| (British Columbia Winter) | VCR-based | 15.9 | 905 | 1.4 | 16 |
| | EHAWG | | | | |

*The heater of sorption unit uses a source of waste heat.
**Based on BC Hydro 2016 rate of 11.27 cents per kWh.

### Example 4

### Performance of EHAWG Using Optimization-Based Controller in Accordance with Embodiments Disclosed Herein

A sample representative of performance improvement using the optimization-based controller is shown in FIG. 11. The efficiency of VCR systems is defined by the coefficient of performance (COP), which is the ratio of the cooling power output to the input power consumption. FIG. 11, shows the behavior of COP versus the speed of condenser fan (that is represented by the air mass flow rate blown by the condenser fan, \dot{m}_{a,cond}) for different speeds of evaporator fan (that is represented by the air mass flow rate blown by the evaporator fan, \dot{m}_{a,evap}) at same ambient condition.

The plot shows that by increasing the speed of condenser fan for any speed of evaporator fan, the COP first increases to a point of maximum value and then starts to decrease. However, the magnitude of this optimum COP does not change sensibly by further increasing the speed of evaporator fan. Based on the results, for each ambient temperature, a point of optimum COP can be found by changing the speed of the fans at evaporator and condenser.

The optimization-based controller can find this point of operation for the VCR and command it to operate optimally. In addition, a same concept is implemented in HAWG for the overall efficiency to achieve the highest rate of water generation with the lowest operating cost.

While illustrative embodiments have been illustrated and described, it will be appreciated that various changes can be made therein without departing from the spirit and scope of the invention.

The embodiments of the invention in which an exclusive property or privilege is claimed are defined as follows:

1. A hybrid atmospheric water generator (HAWG), comprising:
(a) a core atmospheric water generator having an inlet for receiving moisture-containing air and a condensing unit configured to produce condensed liquid water; and
(b) a preconditioning unit configured to increase the humidity of the moisture-containing air prior to introducing the moisture-containing air into the inlet of the core atmospheric water generator.

2. The HAWG of claim 1, wherein the preconditioning unit is further configured to increase the temperature and humidity of the moisture-containing air prior to introducing the moisture-containing air into the inlet of the core atmospheric water generator.

3. The HAWG of claim 1, further comprising a water filtration system configured to eliminate impurities and organics from the condensed liquid water.

4. The HAWG of claim 1, further comprising a water mineralization system configured to add minerals to the condensed water.

5. The HAWG of claim 1, further comprising one or more sensors configured to monitor air temperature, humidity, or a combination thereof as related to the HAWG operation.

6. The HAWG of claim 1, further comprising an optimization-based operation controller configured to efficiently control the functionality of the HAWG to achieve a high rate of water generation with the lowest energy consumption intensity.

7. The HAWG of claim 6, wherein the controller is configured to monitor operating parameters via one or more sensors related to operation of the HAWG.

8. The HAWG of claim 6, wherein the controller controls operating parameters selected from the group consisting of speed of fans, heat exchanger cooling and heating capacity, a speed of a wheel desiccator, a capacity of the core atmospheric water generator, and combinations thereof.

9. The HAWG of claim 1, further comprising one or more fans, each configured to move air to, away from, or between the components of the HAWG.

10. The HAWG of claim 1, further comprising at least one air filter configured to remove dust and impurities from the moisture-containing air before entering the condensing unit or the sorption unit or both.

11. The HAWG of claim 1, wherein the core atmospheric water generator comprises a vapor compression refrigeration system (VCR) configured to condense water from the moisture-containing air by cooling it below its dew point.

12. The HAWG of claim 1, wherein the condensing unit comprises a water condensing heat exchanger coupled to a source of cooling.

13. The HAWG of claim 12, wherein the source of cooling operates based on a systems selected from the group consisting of: i) vapor compression refrigeration (VCR), ii) adsorption cooling; iii) absorption cooling, iv) thermoelectric cooling, vi) gas cycle cooling, vii) air cycle cooling, viii) magnetic refrigeration ix) thermoacoustic refrigeration, x) reverse Stirling cooling, xi) evaporative cooling, xii) steam jet cooling, xiii) pulse-tube refrigeration, xiv) dilution refrigeration configured to condense water from the moisture-containing air by cooling it below its dew point, and combinations thereof.

14. The HAWG of claim 1, wherein the preconditioning unit comprises at least one sorption bed.

15. The HAWG of claim 14, wherein the sorption bed is configured to adsorb and desorb water.

16. The HAWG of claim 14, wherein the sorption bed comprises a desiccant material.

17. The HAWG of claim 16, wherein the desiccant material is selected from the group consisting of gas, liquid, or solid phases of silica gel, molecular sieves, zeolites, activated charcoal, activated alumina, calcium sulfate, calcium chloride, calcium oxide, montmorillonite clay, and combinations thereof.

18. The HAWG of claim 16, wherein the desiccant material is configured to adsorb water from the air in an exothermic process and desorb water into the air in an endothermic process.

19. The HAWG of claim 14, further comprising a heat exchanger configured to heat the sorption bed.

20. The HAWG of claim 1, further comprising a fan configured to direct air into the preconditioning unit.

21. The HAWG of claim 1, wherein the preconditioning unit comprises:
an inlet configured to intake air of a first humidity; and
an outlet in communication with the core atmospheric water generator configured to output air of a second humidity that is greater than the first humidity.

22. The HAWG of claim 21, wherein the preconditioning unit comprises a desiccant wheel.

23. The HAWG of claim 22, wherein the desiccant wheel is configured to rotate in order to expose a dry portion of the desiccant wheel to a charging air stream, providing ambient air, and a moist portion of the desiccant wheel to a drying air stream directed into the core atmospheric water generator.

24. The HAWG of claim 1, wherein the condensing unit is configured to use chilled fluid to provide a cooling source sufficient to condense liquid water from the moisture-containing air.

25. The HAWG of claim 24, wherein chilled fluid is provided by an electricity-driven chiller.

26. The HAWG of claim 25, wherein the electricity-driven chiller is of a type selected from the group consisting of a vapor compression refrigeration chiller, a thermoelectric cooling system, a gas cycle cooling system, an air cycle cooling system, a magnetic refrigeration system, a thermoacoustic refrigeration system, a reverse Stirling cooling system, a evaporative cooling system, a steam jet cooling system, a pulse-tube refrigeration system, a dilution refrigeration system, and combinations thereof.

27. The HAWG of claim 25, wherein the electricity-driven chiller is also configured to receive fluid returned from the condensing unit that is of a temperature greater than the chilled fluid.

28. The HAWG of claim 24, wherein chilled fluid is provided by a chiller that is a mechanically-driven chiller, magnetically-driven chiller, thermally-driven chiller, acoustically-driven chiller, or combinations thereof.

29. The HAWG of claim 28, wherein the chiller is also configured to receive fluid returned from the condensing unit that is of a temperature greater than the chilled fluid.

30. The HAWG of claim 28, wherein the chiller operates using a mechanism selected from the group consisting of adsorption, absorption, and a combination thereof.

31. The HAWG of claim 28, further comprising a thermal energy source configured to provide heated fluid to the chiller and receive cooled fluid from the heat-driven chiller.

32. The HAWG of claim 31, wherein the thermal energy source includes heat from a source selected from the group consisting of electricity, combustion heat, chemical reaction heat, nuclear heat, solar heat, flue gas, exhaust heat, process heat, geothermal heat, waste heat from any application, heat pump, friction heat, compression heat, radiant heat, microwave heat, induction heat, and combinations thereof.

33. The HAWG of claim 31, further comprising a heat exchanger configured to provide a source of heat to the preconditioning unit in order to increase the temperature of the moisture-containing air, wherein the heat exchanger is in fluid communication with the thermal energy source so as to provide heated fluid to the heat exchanger and receive cooled fluid from the heat exchanger.

34. The HAWG of claim 31, further comprising one or more heat exchangers configured to provide a source of heat or cold to the preconditioning unit in order to increase or reduce the temperature of the moisture-containing air and process air, wherein the heat exchangers are in fluid communication with the heat source so as to provide heated or cold fluid to the heat exchanger and receive cooled fluid from the heat exchangers, and wherein there is at least one heating heat exchanger and one cooling heat exchanger.

35. The HAWG of claim 28, wherein the HAWG does not include an electricity-driven chiller.

36. A method of generating liquid water using a HAWG according to any of the preceding claims, the method comprising:
(a) exposing the preconditioning unit to air having a first humidity;
(b) within the preconditioning unit increasing the humidity of the air to provide moist air having a second humidity that is greater than the first humidity;
(c) directing the moist air into the core atmospheric water generator; and
(d) producing liquid water in the core atmospheric water generator.

37. The method of claim 36, wherein the air is moved with one or more fans.

38. The method of claim 36, wherein the preconditioning unit comprises at least one sorption bed and a heat exchanger configured to heat the sorption bed, and wherein the method further comprises the steps of:
exothermically adsorbing water in the sorption bed; and subsequently
heating the sorption bed to desorb the water to provide moist air to the core atmospheric water generator.

39. The method of claim 38, wherein the sorption bed is in the form of a linear sorption bed.

40. The method of claim 38 wherein the sorption bed is in the form of multi-layer stackable sorption materials.

41. The method of claim 38, wherein the sorption bed is incorporated into a wheel desiccator.

42. The method of claim 38, wherein the sorption bed allows for continuous water generation.

43. The method of claim 36, wherein liquid water is produced at a higher rate when compared to the core atmospheric water generator without the preconditioning unit.

44. The method of claim 43, wherein liquid water is produced at a rate of 100% or greater when compared to the core atmospheric water generator without the preconditioning unit.

45. The method of claim 36, wherein the operating parameters of the HAWG are optimally controlled based on the ambient temperature and humidity.

46. The method of claim 45, wherein the operating parameters are selected from the group consisting of speed of fans, heat exchanger power, heat exchanger cooling and heat capacity, a speed of wheel desiccator, a capacity of the core atmospheric water generator, and combinations thereof.
